(19) United States
(12) Patent Application Publication
(10) Pub. No.: US 2015/0330804 A1
(43) Pub. Date: Nov. 19, 2015

(54) INFORMATION DISPLAY DEVICE AND METHOD

(71) Applicant: Furuno Electric Co., Ltd., Nishinomiya (JP)

(72) Inventors: Masato Okuda, Nishinomiya-shi (JP); Takashi Omori, Nishinomiya-shi (JP)

(21) Appl. No.: 14/710,274

(22) Filed: May 12, 2015

(30) Foreign Application Priority Data
May 13, 2014 (JP) 2014-099231

(51) Int. Cl. G01C 21/36

(52) U.S. Cl. CPC G01C 21/3664

(57) ABSTRACT

An information display device is provided. The information display device includes a memory configured to store information along with a position, a display unit configured to display the information, and a controller configured to control the display unit. The controller controls the display unit to simultaneously display a first display section and a second display section. The information is displayed within the first display section when the position is within a first target section and a first display condition is satisfied. The information is displayed within the second display section when the position is within a second target section and a second display condition is satisfied. Each of the first and second display conditions is specifiable by a user.

### CROSS-REFERENCE TO RELATED APPLICATION(S)

This application claims priority under 35 U.S.C. §119 to Japanese Patent Application No. 2014-099231, which was filed on May 13, 2014, the entire disclosure of which is hereby incorporated by reference.

### TECHNICAL FIELD

This disclosure generally relates to an information display device, which displays information of a situation around a predetermined position (e.g., a position of an own position).

### BACKGROUND OF THE INVENTION

JP2013-231844A and JP2012-233743A disclose information display devices which display information of a situation around a predetermined position (e.g., a position of an own position). JP2013-231844A discloses a ship radar apparatus in which a first section and a second section are displayed on a display screen of a display unit. The first section is displayed closer to a display reference point than the second section, and the scale of the first section is smaller than the scale of the second section. JP2012-233743A discloses a radar indicator in which periphery information of the ship is displayed within a radar image display section, and a display target (e.g., an own position, a landmark, or a user registering point) of which position corresponds to a point outside the radar image display section is displayed outside the radar image display section.

Meanwhile, for example, a user who steers a ship, may request to selectively display or not display information of a situation near the ship and information of a situation far from the ship, based on his/her preference or situation. However, the configurations of JP2013-231844A and JP2012-233743A cannot finely answer to the request of such customization of the display setting, which has left a room for improvement.

### SUMMARY OF THE INVENTION

The purpose of this disclosure relates to providing an information display device, which is able to provide information to a user in a form in which overall information and detailed information are well balanced, and flexibly customizable of a display manner of the information.

According to a first aspect of this disclosure, an information display device with the following configuration is provided. Specifically, the information display device includes a GNSS receiver configured to receive an own position from a GNSS sensor, a memory configured to store information along with a position, a display unit configured to display the information, and a controller configured to control the display unit. The controller controls the display unit to simultaneously display a first display section and a second display section. The information is displayed within the first display section when the position at which the information is located is within a first target section and a first display condition is satisfied, the first target section designed to include information of a near area from the own position, the first display condition designed to determine whether to display the information based on a first predetermined condition. The information is displayed within the second display section when the position at which the information is located is within a second target section and a second display condition is satisfied, the second target section designed to include information of a farther area from the own position compared to the first target section, the second display condition designed to determine whether to display the information based on a second predetermined condition. Each of the first and second display conditions is specifiable by a user.

Thus, the information display device (own position) finely customizable of each of display manners for the situation near the information display device (own position) and the situation of a wide area can be achieved.

With the information display device, the number of targets indicated by the information for which whether to display is specifiable by the user in specifying the second display condition is preferably smaller than that in specifying the first display condition.

Thus, the user can specify, with a large degree of freedom, the first display condition that is the display condition of the information of the area near the information display device (own position), and can specify the second display condition that is the display condition of the information of the area comparatively farther from the information display device (own position) in a simple manner of selecting from items of which the number is narrowed down. Moreover, a suitable balance of the amount of the information to be displayed can be naturally achieved between the situation near the information display device (own position) and the situation of the wide area.

With the information display device, the second display condition preferably includes the first display condition so that a same kind of information in the second display section is also displayed in the first display section.

Thus, a relationship between the two display conditions becomes easy to organize, and therefore, the specification of the respective conditions becomes easy.

With the information display device, among the information displayed within the first display section, whether to emphasize the information indicating a target that is detected to be dangerous is preferably specifiable by the user.

Thus, a display screen that reflects the user's preference and the like also in view of whether to emphasize a dangerous situation can be provided.

With the information display device, within the first display section, the information may be displayed small when a distance from the own position is long, and the information may be displayed large when the distance is short.

Thus, the position at which the information is existed can be expressed in perspective, and thus, it can be achieved that a display image that is close to a line of sight of the user and promotes instinctive understanding from the user is provided.

With the information display device, the information displayed within the first display section is preferably dynamic information, and the information displayed within the second display section is preferably static information.

Thus, a change of situation can easily be reflected in the first display section indicating the situation near the information display device (own position), and a movement of the display screen can be suppressed in the second display section indicating the situation comparatively farther from the information display device (own position). As a result, for the user who wants to pay comparatively great attention to the situation near the information display device (own position), the display image corresponding to the user's perspective can be provided.

With the information display device, the information displayed within the first display section is preferably either one of information received through external communication and information detected by a sensor. The information displayed within the second display section is preferably information obtained from map information.

Thus, the reasonable display manner can be achieved in each of the first display section and the second display section.

With the information display device, the information received through the external communication preferably includes any of weather, wind direction, wind speed, water temperature, water current, and information of other ship.

Thus, the information including weather that is important to the user can be displayed at least in the first display section.

With the information display device, the information detected by the sensor preferably includes information detected by either one of a radar and a sonar.

Thus, a detailed situation near the information display device (own position) can be displayed at least in the first display section.

With the information display device, the second display section is preferably disposed on an upper side of the first display section in vertical directions of the first display section.

Thus, a natural positional relationship between a near view and a distant view can be obtained on the display screen.

With the information display device, the first display section may have a circular shape, the second display section may have an annular shape, and the first display section may be disposed radially inward of the second display section.

Thus, the user can easily understand both of the situation of the wide area and the situation of the near area over all azimuths with respect to the information display device (own position).

According to a second aspect of this disclosure, the following method of displaying information that is stored along with a position, on a display unit of a device is provided. The method includes causing the display unit to simultaneously display a first display section and a second display section. The information is displayed within the first display section when the position at which the information is located is within a first target section and a first display condition is satisfied, the first target section designed to include information of a near area from the own position, the first display condition designed to determine whether to display the information based on a first predetermined condition The information is displayed within the second display section when the position at which the information is located is within a second target section and a second display condition is satisfied, the second target section designed to include information of a farther area from the own position compared to the first target section, the second display condition designed to determine whether to display the information based on a second predetermined condition. Each of the first and second display conditions is specifiable by a user.

Thus, the information display device (own position) finely customizable of each of display manners for the situation near the information display device (own position) and the situation of a wide area can be achieved.

With the method of displaying the information, the number of targets indicated by the information for which whether to display is specifiable by the user in specifying the second display condition is preferably smaller than that in specifying the first display condition.

Thus, the user can specify, with a large degree of freedom, the first display condition that is the display condition of the information of the near area of the information display device (own position), and can specify the second display condition that is the display condition of the information of the area comparatively farther from the information display device (own position) in a simple manner of selecting from items of which the number is narrowed down. Moreover, a suitable balance of the amount of the information to be displayed can be naturally achieved between the situation near the information display device (own position) and the situation of the wide area.

With the method of displaying the information, the information displayed within the first display section preferably includes dynamic information, and the information displayed within the second display section preferably includes static information.

Thus, a change of situation can easily be reflected in the first display section indicating the situation near the information display device (own position), and a movement of the display screen can be suppressed in the second display section indicating the situation comparatively farther from the information display device (own position). As a result, for the user who wants to pay comparatively great attention to the situation near the information display device (own position), the display image corresponding to the user's perspective can be provided.

With the method of displaying the information, the information displayed within the first display section preferably includes either one of information received through external communication and information detected by a sensor. The information displayed within the second display section is preferably information obtained from map information.

Thus, the reasonable display manner can be achieved in each of the first display section and the second display section.

### BRIEF DESCRIPTION OF THE DRAWINGS(S)

The present disclosure is illustrated by way of example and not by way of limitation in the figures of the accompanying drawings, in which the like reference numerals indicate like elements and in which:

FIG. 1 is a block diagram illustrating an overall configuration of a ship instrument network system provided with a multi-function display device according to one embodiment of this disclosure;

FIG. 2 is a front view illustrating an external view of the multi-function display device;

FIG. 3 is a view illustrating a plotter image displayable by the multi-function display device;

FIG. 4 is a view illustrating a three-dimensional navigation image;

FIG. 5 is a view illustrating a setting screen related to three-dimensional navigation;

FIG. 6 is a flowchart illustrating processing when a display target is displayed in the three-dimensional navigation image;

FIG. 7 is a view illustrating another example of the three-dimensional navigation image; and

FIG. 8 is an example of a radar image.

### DETAILED DESCRIPTION

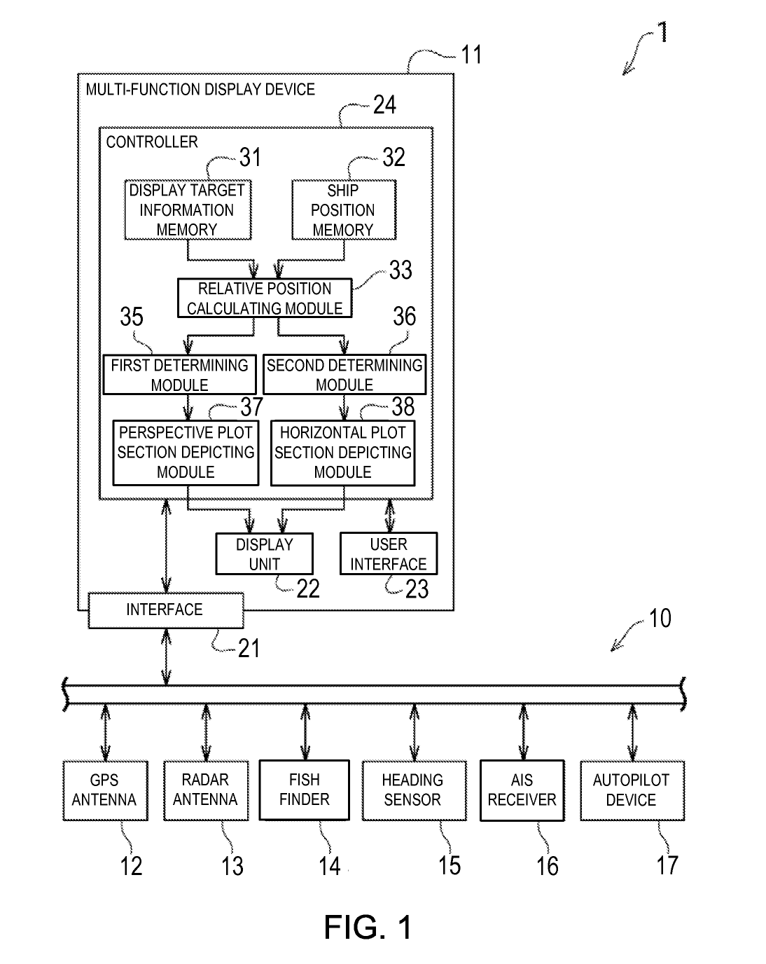

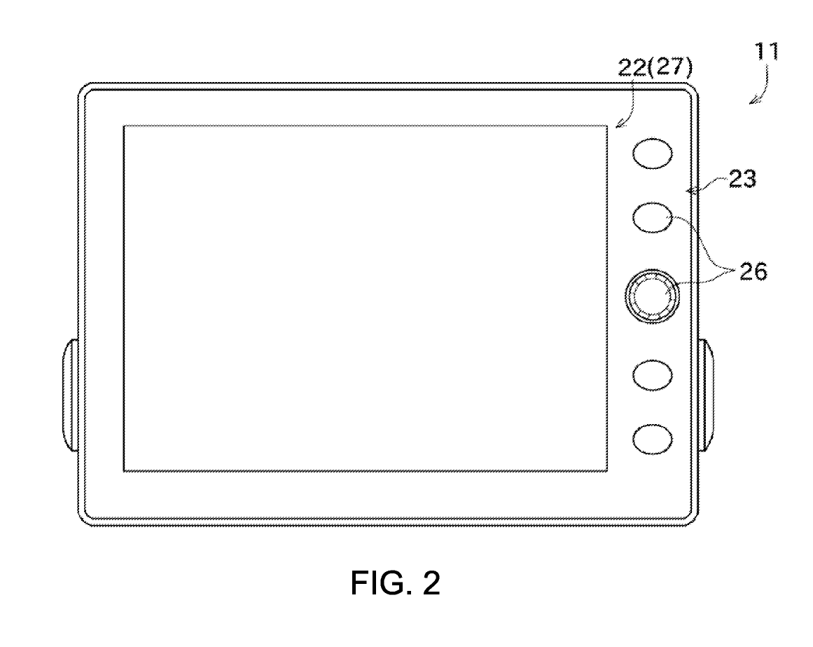

Next, one embodiment of this disclosure is described with reference to the appended drawings. FIG. 1 is a block diagram illustrating an overall configuration of a ship instrument network system 1 provided with a multi-function display device 11 according to this embodiment of this disclosure. FIG. 2 is a front view illustrating an external view of the multi-function display device 11.

The ship instrument network system 1 includes a plurality of ship instruments connected with a network 10. The ship instruments exchange detected information and the like, via the network 10. As the standard of the network 10, a LAN (Local Area Network) or a CAN (Controller Area Network) may be adopted, for example.

As illustrated in FIG. 1, the ship instrument network system 1 of this embodiment includes the multi-function display device (information display device) 11, a GPS antenna (GNSS sensor) 12, a radar antenna 13, a fish finder 14, a heading sensor 15, an AIS receiver 16, and an autopilot device 17. Hereinafter, these components may be referred to as the “ship instruments.”

The multi-function display device 11 creates an image (sensor image) based on the information detected by the other ship instruments (sensors) and displays it, and performs various kinds of processing according to operation by a user.

Hereinafter, a specific configuration of the multi-function display device 11 is described. The multi-function display device 11 includes an interface 21, a display unit 22, a user interface 23, and a controller 24.

The interface 21 is configured as a network adaptor, etc. The multi-function display device 11 transceives various kinds of information with the other instruments configuring the ship instrument network system 1, via the interface 21.

The display unit 22 includes a liquid crystal display unit and displays the sensor image, various setting screens and the like on a display screen according to operation by the user. The sensor image is an image in which the information acquired by the sensor instruments is expressed graphically. Examples of the sensor image include a plotter image illustrating a nautical chart around a ship to which the ship instrument network system 1 (hereinafter, may be referred to as “the first ship,” “the reference ship” or simply “the ship”) is mounted, a radar image illustrating radar echoes around the first ship, a fish finding image of the fish finder, and also a three-dimensional navigation image described later.

As illustrated in FIG. 2, the user interface 23 includes various hardware keys 26 disposed near the display screen of the display unit 22, and a touch panel 27 disposed to the display screen of the display unit 22. The user can perform various instructions to the multi-function display device 11 by controlling the hardware keys 26 and touching the touch panel 27 of the display screen.

The controller 24 illustrated in FIG. 1 includes an operation unit (e.g., a CPU), and a memory comprised of a ROM and a RAM. These kinds of hardware cooperate with a display control program stored in the memory to control the display on the display unit 22.

Specifically, the controller 24 of the multi-function display device 11 creates various kinds of the sensor images as needed based on the stored contents in the memory and the information received from the other ship instruments, and displays them on the display unit 22. Particularly, as one of the sensor images, the controller 24 may display a navigation image in which a situation around an area in front of the first ship in its traveling route is expressed three-dimensionally (hereinafter, may be referred to as the “three-dimensional navigation image”). Note that, a control performed by the controller 24 for the three-dimensional navigation image is described later.

The GPS antenna 12 receives positioning signals from GPS satellites (GNSS satellites) and outputs them to the multi-function display device 11 and the like, via the network 10. The controller 24 of the multi-function display device 11 obtains a position of the first ship (specifically, a position of the GPS antenna) based on the positioning signals and stores it in a ship position memory 32 provided to the controller 24. Note that, a configuration in which the calculation for obtaining the position based on the positioning signals is performed on the GPS antenna 12 side and the position of the first ship (hereinafter, simply referred to as the “first ship position”) is outputted to the multi-function display device 11 by the GPS antenna 12 may be adopted.

Here, the first ship position obtained by the GPS positioning described above indicates a terrestrial reference absolute position expressed by longitude and latitude. Note that, in the following description, such a terrestrial reference absolute position may be referred to as the absolute position.

The multi-function display device 11 exerts a function as a navigation device based on the first ship position obtained in the GPS positioning and nautical chart information (map information) stored in the multi-function display device 11 itself. Specifically, based on the obtained ship position and the stored nautical chart information, the multi-function display device 11 displays the first ship position on the display unit 22, by superimposing it on the nautical chart (plotter image). Moreover, the multi-function display device 11 obtains a ground speed and a trace of the first ship by utilizing ship position changed over time, and displays them on the display unit 22. Further, through the user selecting waypoints (a final destination and stopover points), the multi-function display device 11 creates a navigation route (designed route) and displays it on the display unit 22.

Note that, the GPS antenna 12 of this embodiment performs the positioning by a method called “differential GPS” (DGPS) so as to obtain the first ship position highly accurately. Specifically, GPS positioning errors are calculated at multiple DGPS base stations placed in Japan to cover the coastal sea areas of Japan, and the positioning errors (DGPS beacons) are broadcasted as correction information from the DGPS base stations. The GPS antenna 12 has a function as a DGPS beacon receiver, and by correcting the positioning result based on the correction information included in the DGPS beacons, the GPS antenna 12 can obtain the first ship position more accurately.

Each DGPS beacon described above may contain meteorological information and/or hydrographic information observed at a predetermined observation location (e.g., a lighthouse) close to the corresponding DGPS base station. The GPS antenna 12 can output the meteorological information and the hydrographic information (e.g., weather, a wind direction, a wind speed, a water temperature, and an ocean flow) and the position of the observation location which are obtained from the DGPS beacons, to the multi-function display device 11.

The radar antenna 13 constitutes a radar (sensor), and it transmits a microwave and receives a reflection wave from an object. The reflection wave is suitably signal-processed and then outputted to the multi-function display device 11. The multi-function display device 11 creates one of the radar images based on the reflection wave. Specifically, the controller 24 of the multi-function display device 11 obtains a distance of the object from the radar antenna 13 based on a time length from the transmission of the microwave to the reception of the reflection wave. Moreover, the controller 24 obtains a direction in which the object exists, based on a direction to which the microwave is transmitted. The controller 24 creates the radar image as described above and displays it on the display unit 22.

The multi-function display device 11 achieves a TT (Target Tracking) function by utilizing information obtained from the radar antenna 13. Although the detailed description of the TT function (ARPA function) is omitted since it is known, the TT function is for estimating a speed vector of a target object by automatically detecting and acquiring a position of the target object based on the radar echo obtained from the radar antenna 13, and tracking a movement of the target object over time. Thus, the controller 24 of the multi-function display device 11 can display the target object (e.g., another ship) currently tracked, on the display unit 22 by superimposing it on the sensor images, such as the plotter image, the radar image, and the three-dimensional navigation image.

Note that, due to the property of the radar detection, the position of the target object (e.g., other ship) obtained by the TT function described above should be considered as position relative to the first ship. In other words, the position of the target object obtained by using the TT function (TT target object) is based on a distance from the first ship and an azimuth with respect to the first ship.

The fish finder 14 is comprised of a transducer and an analyzer. The transducer is installed in, for example, the bottom of the first ship, and discharges an ultrasonic wave directly below into the water at a predetermined timing (e.g., every predetermined period of time) and receives a reflection wave from the water bottom or a school of fish. The analyzer creates data indicating the school of fish or the like by analyzing the received reflection wave, and outputs it to the multi-function display device 11. The controller 24 of the multi-function display device 11 creates the fish finding image based on the received data and displays it on the display unit 22.

The heading sensor 15 detects a heading of the first ship (a direction to which a bow of the first ship is oriented) by a terrestrial reference absolute azimuth. Generally, a ship travels forward, toward its bow direction. Therefore, it can be said that the heading sensor 15 detects an azimuth of the forward direction of the hull of the first ship. For example, a magnetic azimuth sensor or a GPS compass may be used as the heading sensor 15.

The AIS receiver 16 receives AIS information outputted from an AIS (Automatic Identification System) installed in other ships (second ships). The AIS information includes the information of, for example, a position (absolute position), speed, and course of the corresponding second ship. The AIS receiver 16 outputs the AIS information received from the second ship, to the multi-function display device 11. The controller 24 of the multi-function display device 11 can display an AIS symbol indicating the second ship by superimposing it on the various sensor images, based on the received information.

The autopilot device 17 automatically controls a rudder of the first ship so that the first ship moves on the designed navigation route. Specifically, the autopilot device 17 obtains required change in the heading of the first ship based on the heading acquired from the heading sensor 15 and the navigation route acquired from the multi-function display device 11. Further, by changing a rudder angle according to the obtained value, the autopilot device 17 matches the course of the first ship with the navigation route.

The ship instrument network system 1 of this embodiment is configured as described above. Note that, the ship instruments constituting the ship instrument network system 1 are arbitrary, and a configuration in which ship instrument(s) (e.g., a sonar which is a kind of sensor) other than those described above are connected, or a configuration in which a plurality of similar types of ship instruments are connected may be adopted. Moreover, a configuration in which the processing of the data acquired by the ship instruments is performed by the ship instruments themselves may be adopted, or a configuration in which the processing of the data acquired by the ship instruments is performed by the controller 24 of the multi-function display device 11 may be adopted.

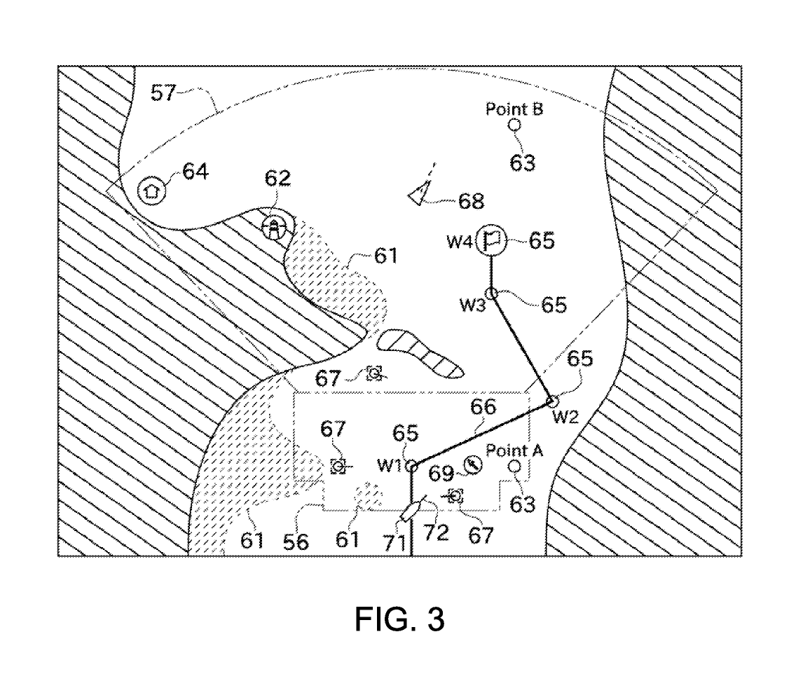

Next, an example of displaying the plotter image which is one of the sensor images displayable in the multi-function display device 11 is described with reference to FIG. 3.

Note that, hereinafter, the contents displayed on the display unit 22 in a case where the display screen is oriented vertically are described. However, without limiting to this, even when the display screen is oriented in other direction, for example, horizontal, the configuration disclosed herein can similarly be applied.

The display unit 22 of the multi-function display device 11 graphically displays the first ship position on the nautical chart based on the current positional information of the first ship obtained from the GPS antenna 12 (displays the plotter image).

An example of the display contents of the plotter image is illustrated in FIG. 3. In the plotter image, the nautical chart information stored in the multi-function display device 11 is displayed.

The nautical chart information is an electronic record of the shape of coast line, water depths, positions of lighthouses and channel buoys, etc. The nautical chart information includes information of positions of dangerous areas where the water depth is shallow, and information of positions and names of landmarks.

The landmark is a reference mark during movement. Specific examples of the landmark during navigation include a lighthouse, a port, a mountain, an island, and a channel buoy. Note that, the definition of the landmark used herein does not only include what exists on land, but also what is disposed on water, such as the channel buoy.

The plotter image of FIG. 3 includes shallow water areas 61 indicating areas where the water depth is shallow and a landmark symbol 62 indicating a lighthouse which is a landmark.

Further, in the plotter image, point marks 63 which are user registering points, and a homeport mark 64 indicating a homeport of a particular case of the user registering point are displayed by superimposing them on the nautical chart.

The user registering point means a position registered by the user. For example, when a large amount of fish is caught at a certain point or existence of a school of fish is detected by the fish finder 14, the user can register the current position of the first ship as the user registering point by controlling the user interface 23. When the user registering point is created, the first ship position obtained by the GPS positioning, the date and time of the point registered, and the name of the point entered by the user, and the like are stored in the multi-function display device 11.

Further, in the plotter image, destination marks 65 indicating the selected waypoints, route lines 66 indicating a course to the destination (navigation route), and a wind direction-and-speed icon 69 indicating the wind status are displayed.

The navigation route means a scheduled route specified in the multi-function display device 11 by the user according to a navigation plan. For example, in a state where the nautical chart is displayed on the display screen of the display unit 22, the user performs touch operation on arbitrary locations to enter a desired final destination of the first ship, stopover points (intermediate destinations) to pass on the way to the final destination, and the like, to be the waypoints.

The selected waypoints are denoted with numbers indicating a passing order. The numbers are displayed near the destination marks 65. In this embodiment, the n-th waypoint is displayed with “Wn”; however, the display mode is not limited. Further, the route lines 66 are displayed to connect the waypoints (destination marks 65) in order. The destination marks 65 indicating the intermediate waypoints W1 to W3 are circle marks, whereas the destination mark 65 indicating the final destination waypoint W4 is a flag mark, so that the final destination which is considered to be more important to the user is displayed to stand out.

The wind direction-and-speed icon 69 indicates the wind direction and the wind speed included in the meteorological information obtained from the DGPS beacons, and is displayed at a point corresponding to the position where they are observed. In the wind direction-and-speed icon 69, the wind direction is expressed by the direction of an arrow, and the wind speed is expressed by the length of the arrow.

Further, in the plotter image, the current position of the first ship is displayed as a boat icon 71, and the heading is displayed as a designed course 72 in autopilot. Furthermore, in the plotter image, a TT target icon 67 indicating the TT target object described above (e.g., other ship), and an AIS second ship icon 68 indicating the second ship obtained by the AIS receiver are displayed. When the situation of the first ship, the second ship or the like is changed, the display position, orientation and/or the like of the corresponding icon are updated in real time.

Note that, the chain-lined sections in FIG. 3 (a first target section 56 and a second target section 57) are illustrated to describe the control of the three-dimensional navigation image described later, and are not actually displayed in the plotter image. Moreover, although it is not displayed in FIG. 3, a predicted traveling direction of the first ship, an actual trace of the first ship and the like can also be displayed in the plotter image in addition to the above contents.

Next, the three-dimensional navigation image is described. In the three-dimensional navigation image, the situation around the area in front of the first ship traveling on the designed navigation route is expressed in perspective.

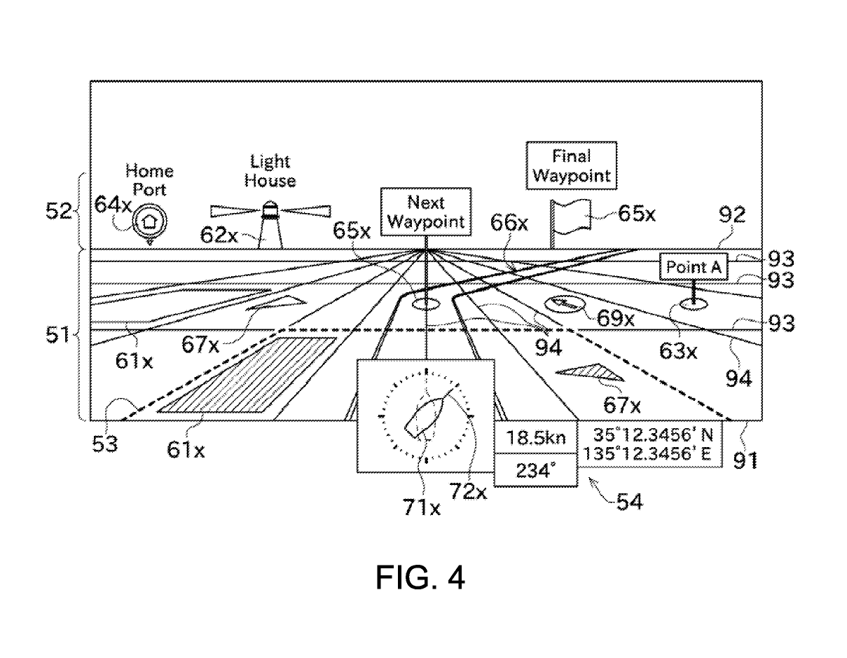

The example of the display contents of the three-dimensional navigation image is illustrated in FIG. 4. Note that, the three-dimensional navigation image in FIG. 4 illustrates the same situation as the plotter image illustrated in FIG. 3, with a different view point.

As illustrated in FIG. 4, a first reference line 91 extending in the lateral directions of the display unit 22 is displayed at the bottom of the three-dimensional navigation image, and a second reference line 92 extending in the lateral directions is displayed above the first reference line 91.

The first and second reference lines 91 and 92 are oriented horizontally and in parallel to each other. Moreover, a plurality of horizontal straight lines 93 are depicted between the first and second reference lines 91 and 92, and the horizontal straight lines 93 are arranged such that an interval therebetween becomes narrower toward the second reference line 92 at the top.

A plurality of perspective lines 94 spreading radially from the center of the second reference line 92 in the lateral directions (the vanishing point in one-point perspective) are depicted between the first and second reference lines 91 and 92. By these lines 91 to 94, the water surface (sea surface) spreading around the first ship is expressed in perspective such that the upper side corresponds to the farther side and the lower side corresponds to the closer side.

In the section where the water surface is expressed (i.e., the section between the first and second reference lines 91 and 92), the various kinds of icons, symbols and marks other than that indicating the first ship are displayed such that their display positions change in the lateral directions (horizontal directions) according to the azimuth thereof with respect to the first ship. Moreover, the icons and the like change their display positions and sizes in the vertical directions according to the distance thereof from the first ship. In other words, the perspective is expressed by displaying the icons and the like lower and larger as the distance thereof is closer from the first ship. Therefore, in the following description, this section may be referred to as the perspective plot section (first display section) 51.

In the perspective plot section 51, a near view seen from the first ship is displayed. The user can grasp the azimuth and the distance of an object or point which requires attention with respect to the first ship, by looking at the display positions and sizes of the symbols and marks disposed within the perspective plot section 51.

The various kinds of icons, symbols and marks other than that indicating the first ship are displayed in the upper part of the perspective plot section 51 such that the display positions thereof change in the lateral directions (horizontal directions) according to the azimuth thereof with respect to the first ship. Note that, each of the icons and the like is always displayed at right above the second reference line 92 and in a fixed size, regardless of the distance from the first ship. Therefore, in the following description, this section may be referred to as the horizontal plot section (second display section) 52.

In the horizontal plot section 52, a distant view seen from the first ship is displayed. However, since the expression in perspective is eliminated as described above, a symbolic expression is provided in which simplicity and explicitness are more prioritized than realistic perspective. The user can understand whether the observed object or point is far to some extent from the first ship and grasp the azimuth thereof with respect to the first ship, by looking at the symbols and marks disposed within the horizontal plot section 52.

In the perspective plot section 51, objects, TT target objects, marks and the like which are located relatively close to the first ship (a shallow water area 61x, a point mark 63x, a next destination mark 65x, a TT target icon 67x, and a wind direction-and-speed icon 69x) are displayed. In the horizontal plot section 52, objects, marks and the like which are located relatively far from the first ship (a landmark symbol 62x, a homeport mark 64x, a final destination mark 65x) are displayed.

In the horizontal plot section 52 corresponding to the distant view, compared with the perspective plot section 51 corresponding to the near view, only the icons and the like which are narrowed down based on, for example, whether they are important or easy to be reference marks are displayed. The condition for displaying the icons and the like is different between the perspective plot section 51 and the horizontal plot section 52. Note that, in each of the perspective and horizontal plot sections 51 and 52, the condition for displaying the icons and the like can be determined by the user as described later.

In the perspective plot section 51, a guard line 53 is displayed to surround an area close to the first ship. When the dangerous area, the objects and/or the like are inside the section defined by the guard line 53 (guard zone), they are displayed in a different mode from dangerous areas and the objects outside the section defined by the guard line 53, so as to inform the user that the possibility of being stranded or collision is high. In FIG. 4, a situation where the shallow water area 61x and the TT target icon 67x are displayed in red color so as to be emphasized since they are inside the section defined by the guard line 53 is hatched for the sake of convenience. Any display mode may be adopted to differentiate the objects and the like which are inside the section defined by the guard line 53; however, the display mode is preferably changed such that the objects and the like are displayed in a color that stands out as described above, or displayed to blink, so as to attract attention from the user.

Note that, there is a case where the objects and the like are preferably displayed to be emphasized even though they are not inside the section defined by the guard line 53. For example, for the TT target icon 67x, a distance between the object and the first ship when they approach each other the most (closest distance) is calculated, and if the obtained distance is shorter than a predetermined distance, the TT target icon 67x is preferably displayed to be emphasized even if it is outside the section defined by the guard line 53 and the possibility of collision against the first ship is preferably informed to the user. Since the calculating method of the closest distance is broadly known in the TT function, the detailed description thereof is omitted.

A boat icon 71x and a setting course 72x for autopilot are displayed at the center of the first reference line 91 in the lateral directions and indicate the relative position and the heading of the first ship with respect to the navigation route (route lines 66x). Moreover, the speed of the first ship, the absolute position of the first ship obtained by the GPS positioning and the like are displayed on the side of the boat icon 71x in the form of a digital meter. Thus, a meter section 54 is formed. The user can understand a specific situation of the first ship and therearound by checking the contents in the meter section 54.

Note that, when the relative position of the first ship with respect to the navigation route (route lines 66x) is changed in one of the lateral directions, the display position of the boat icon 71x is not changed, but instead, the display positions of the objects and the marks within the perspective plot section 51 and the horizontal plot section 52 are entirely changed in the corresponding direction. By constantly fixing the display position of the first ship to the center of the lateral directions as above, the image close to the user's perspective in actually steering the first ship can be provided.

Next, in the multi-function display device 11, a configuration of the controller 24 for displaying the perspective and horizontal plot sections 51 and 52 in the three-dimensional navigation image described above is described.

The controller 24 includes a display target information memory (memory) 31, a ship position memory 32, a relative position calculating module 33, a first determining module 35, a second determining module 36, a perspective plot section depicting module 37, and a horizontal plot section depicting module 38.

The display target information memory 31 stores information of various display targets which may be displayed in the three-dimensional navigation image. The display targets include the dangerous area stored in the nautical chart and where the water depth is shallow, the landmark, the TT target object (e.g., other ship), the second ship received by the AIS, the user registering point, the navigation route (waypoints), and the meteorological information/hydrographic information obtained by the DGPS beacons.

The display target information memory 31 stores the information of the display targets and the information of the positions of the display targets. Note that, among the display targets, for the dangerous areas where the water depth is shallow, the landmarks, the second ships, the user registering points, the navigation route (waypoints), and the meteorological information/hydrographic information, the terrestrial reference absolute positions are stored as the positions thereof in the display target information memory 31. On the other hand, for the TT target object, the relative position with respect to the first ship is stored in the display target information memory 31.

The memory contents (display targets) in the display target information memory 31 can be categorized into dynamic information which is frequently (in real time) updated and static information which is hardly updated. For example, since the TT target object or the second ship is updated by latest information as the position thereof is changed, it may be referred to as the dynamic information. On the other hand, the dangerous area stored in the nautical chart information and where the water depth is shallow, the landmark and the like may be referred to as the static information.

Moreover, the stored contents in the display target information memory 31 can be categorized into the information received through external communication, the information detected by the sensors, and the information obtained from the nautical information. For example, the second ship information is information obtained by receiving the AIS information from the second ship, and the meteorological information/hydrographic information is information obtained by receiving the DGPS beacons from the DGPS base stations. Meanwhile, the TT target object information is information obtained based on the detection result of the radar which is a sensor. The information of the dangerous area where the water depth is shallow, and the landmark are information obtained from the nautical chart information.

The first ship position memory 32 stores the absolute position of the first ship obtained based on the positioning signals from the GPS antenna 12. The stored contents in the first ship position memory 32 are updated by the latest ship position every time the GPS positioning is repeated and the first ship position is newly acquired.

The relative position calculating module 33 calculates, with respect to the first ship, the relative position (distance and azimuth) of each of the display targets stored in the display target information memory 31. The absolute position of the first ship stored in the first ship position memory 32 is used to calculate the relative position. Note that, regarding the TT target object, since the relative position is already stored in display target information memory 31, the relative position is not calculated by the relative position calculating module 33.

The first determining module 35 determines whether the information of the position of the display target is within the first target section (the section defined by the reference numeral 56 in FIG. 3) which is near and in front of the first ship traveling the navigation route with respect to the position of the first ship and the extending direction of the navigation route. The first target section 56 is defined to have a certain distance from the position of the first ship and a certain azimuth range. The first determining module 35 allows the display target to be displayed within the perspective plot section 51, when the position of the display target is within the first target section 56 and a first display condition is satisfied.

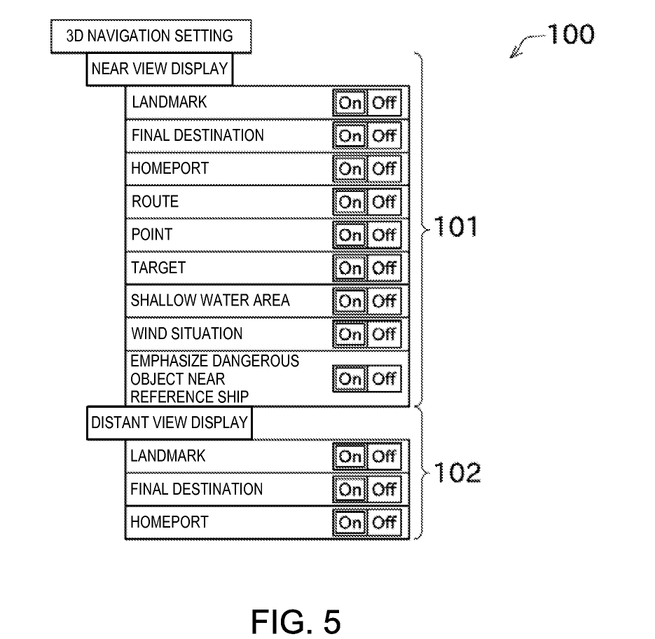

The first display condition is for determining whether to display each display target based on the kind thereof. The user can specify the condition in a three-dimensional navigation setting screen described later (see the “near view display” section 101 in FIG. 5). For example, since the items indicated by the shallow water area 61, the TT target icon 67, and the AIS second ship icon 68 can be dangerous if they approach the first ship, it is extremely preferred to display them within the perspective plot section 51. Also for the other symbols and marks (e.g., the landmark symbol 62x, the point mark 63x, the homeport mark 64x, and the destination mark 65x), since there is high possibility for the user to obtain useful information if they are displayed, it is preferred to display them within the perspective plot section 51.

The second determining module 36 determines whether the positions of the display target is within the second target section (the section defined by the reference numeral 57 in FIG. 3) and a second display condition is satisfied. The second target section 57 is a section comparatively far from the first ship in the forward direction in the navigation route. The second target section 57 is also defined with reference to the position of the first ship and the extending direction of the navigation route, similar to the first target section 56. Moreover, the distance range of the second target section 57 indicates distance farther than the first target section 56. When the relative positions of the display targets are within the second target section 57 and the second display condition is satisfied, the second determining module 36 allows the display target to be displayed.

Similar to the first display condition, the second display condition is for determining whether to display each display target based on the kind thereof. The user can specify the second condition in the three-dimensional navigation setting screen (see the “distant view display” section 102 in FIG. 5). Note that, for the shallow water area 61x, the TT target icon 67x and the destination marks 65x excluding the final destination, if they are located far from the first ship, displaying them is not only unuseful, but also complicates the view on the display screen. Therefore, with the multi-function display device 11 of this embodiment, the setting for whether to display the contents in the second display condition can only be performed for the landmark, the final destination, and the homeport, and the other contents are always not displayed.

Note that, the first and second target sections 56 and 57 are described by using the plotter image in FIG. 3 for the sake of convenience. The first and second target sections 56 and 57 are not designed for the plotter image, but are defined based on the actual positional relationships with the first ship and the navigation route.

Hereinafter, a case of narrowing down the display contents described above is described by comparing the plotter image of FIG. 3 with the three-dimensional navigation image of FIG. 4. In the plotter image of FIG. 3, contents including the shallow water area 61, the landmark symbol 62, the point mark 63, the homeport mark 64, the plurality of destination marks 65, the TT target icon 67, and the AIS second ship icon 68 are located within the second target section 57. In this embodiment, only the landmark symbol 62x which is easily viewable as a reference mark even from a far distance in practical use, the homeport mark 64x, and one of the destination marks 65x that indicates the final destination (W4), are displayed within the horizontal plot section 52 of the three-dimensional navigation image (FIG. 4). Since the various symbols and marks are narrowed down first before being displayed within the horizontal plot section 52 as above, the user can accurately obtain the information useful in navigation without feeling complexity from the view on the display screen.

The perspective plot section depicting module 37 controls the display unit 22 to depict the display target which is allowed by the first determining module 35 to be displayed, in the perspective plot section 51 of FIG. 4. Here, the display target is controlled in its depicted position in the lateral directions such that, with respect to the straight line drawn from the first ship to be in parallel to the navigation route, the display target is displayed more leftward as the distance of the display target from the first ship to the left direction becomes longer, and more rightward as the distance of the display target from the first ship to the right direction becomes longer. Moreover, in a lower part of the perspective plot section 51, the perspective plot section depicting module 37 depicts the display target which is close to the first ship, in a large size. In an upper part of the perspective plot section 51, the perspective plot section depicting module 37 depicts the display target which is far from the first ship, in a small size.

The horizontal plot section depicting module 38 controls the display unit 22 to depict the display target which is allowed by the second determining module 36 to be displayed, in the horizontal plot section 52 of FIG. 4. Here, the display target is controlled in its depicted position in the lateral directions such that the display target is displayed more leftward as the azimuth of the display target with respect to the first ship shifts leftward from the navigation route, and more rightward as the azimuth of the display target with respect to the first ship shifts rightward from the navigation route. Note that, the horizontal plot section depicting module 38 controls the display unit 22 such that the depicted position of the display target in the up-and-down directions does not change (at immediately above the second reference line 92) and the size thereof does not change regardless of the distance of the display target from the first ship.

Thus, within the perspective plot section 51 of the three-dimensional navigation image of FIG. 4, the shallow water area 61x, the point mark 63x, the destination mark 65x closest to the first ship in the forward direction of the navigation route, the route lines 66x, the TT target icons 67x, and the wind direction-and-speed icon 69x are displayed in perspective according to the distances and azimuths with respect to the first ship. Moreover, within the horizontal plot section 52, the landmark symbol 62x, the homeport mark 64x, and the final destination mark 65x are displayed by being aligned on the second reference line 92 according (only) to the azimuths thereof with respect to the first ship.

Note that, among the display targets displayed within the perspective plot section 51, the TT target icon 67x can be said to be the dynamic information described above, which is detected by the radar apparatus which is a sensor. The wind direction-and-speed icon 69x can be said to be the meteorological information/hydrographic information received through the external communication (DGPS beacons). Further, among the display targets displayed within the horizontal plot section 52, the landmark symbol 62x can be said to be the static information described above, which is obtained from the nautical chart information.

As described above, for the display targets in the near view (target objects and points), the positional relationship to which the distance from the first ship is reflected is expressed within the perspective plot section 51. For the display targets in the distant view, the positional relationship to which only the azimuth with respect to the first ship is reflected regardless of the distance from the first ship is expressed within the horizontal plot section 52. Thus, for the near view, the user can instinctively understand the situation around the first ship in perspective, and as for the distant view, the user accurately can understand the information useful in the navigation of the first ship, such as a substantial azimuth of a particularly important location.

Next, the three-dimensional navigation setting screen provided for the user to specify the first and second display conditions is described with reference to FIG. 5.

The controller 24 of the multi-function display device 11 controls the display unit 22 to display the three-dimensional navigation setting screen 100 as illustrated in FIG. 5, according to the operation of the user interface 23. The three dimensional navigation setting screen 100 has the “near view display” section 101 and the “distant view display” section 102, and the user can specify the display targets to be displayed and the display targets to be non-displayed. Note that, the “near view display” means the display setting for the perspective plot section 51, and the “distant view display” means the display setting for the horizontal plot section 52.

In the “near view display” section 101, whether to display or not can be specified for each of the landmark, the final destination (i.e., the waypoint indicating the final destination), the homeport, the route (i.e., the route lines and the waypoints excluding the final destination), the points (user registering points), the targets (TT targets and AIS second ship symbols), the shallow water area, and a wind situation (wind direction-and-speed icon). The specification can be performed by using the touch panel 27 provided to the display unit 22, and the user can specify by touching a position corresponding to an on/off button of each item. Thus, the user can specify the display targets to be displayed within the perspective plot section 51 indicating the near view (first display condition) as he/she prefers.

Moreover, in the “near view display” section 101, when a dangerous object is detected near the first ship, it can be specified whether to display it in an emphasized manner. Thus, the user can specify whether to display it in the emphasized manner as illustrated in FIG. 4 when the shallow water area inside the section defined by the guard line 53 or the TT target object of which the closest distance is shorter than a predetermined distance is detected.

In the “distant view display” section 102, whether to display or not can be specified for each of the landmark, the final destination, and the homeport. Thus, the user can specify the display targets to be displayed within the horizontal plot section 52 indicating the distant view (second display condition) as he/she prefers.

Note that, the number of targets of information for which whether to display can be specified by the user in the “distant view display” section 102 is smaller than that in the “near view display” section 101. Thus, the setting for display can be performed with a large degree of freedom for the near view, and in a simple manner for the distant view. Moreover, a suitable balance of the amount of the information to be displayed can be naturally achieved between the situation near the first ship and a situation of a wide area.

Furthermore, the specification of whether to display by the user in the “distant view display” section 102 can only be performed for one or some of the targets of information for which the user can specify whether to display in the “near view display” section 101. Therefore, the relationship between the first and second display conditions becomes easy to organize, and thus, it becomes easy to specify each condition.

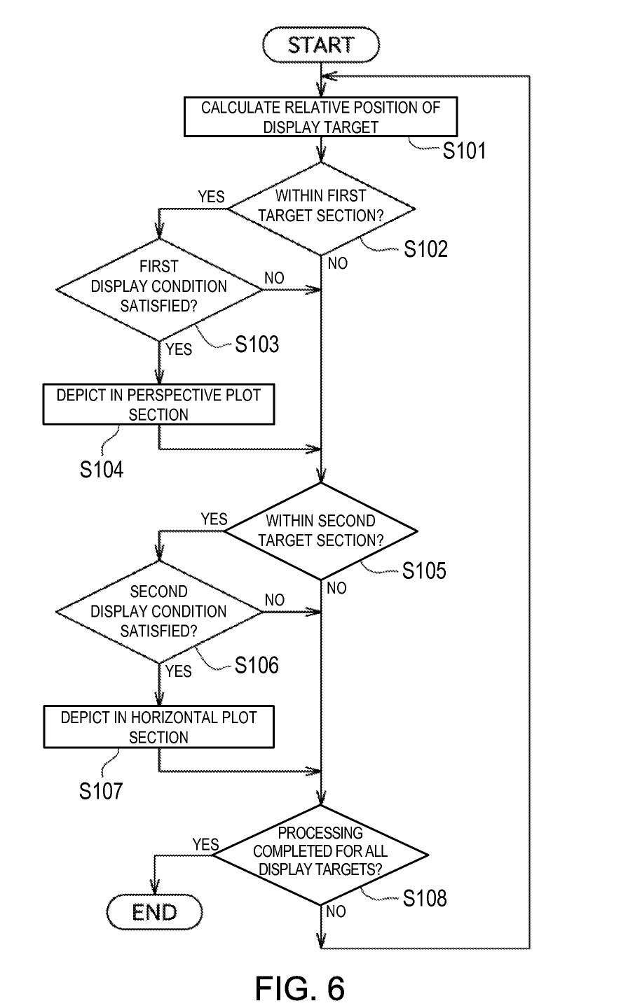

Hereinafter, the depiction processing performed by the controller 24 to create the three-dimensional navigation image is described with reference to the flowchart of FIG. 6. FIG. 6 is a flowchart illustrating processing performed by the controller 24 to display the three-dimensional display target.

First, the controller 24 calculates the relative position of the display target (the distance from the first ship or the azimuth with respect to the first ship) based on the absolute position of each display target of which position is stored in the display target information memory 31 and the absolute position of the first ship obtained from the GPS positioning (S101). Note that, although it is not particularly indicated in the flowchart of FIG. 6, among the display targets, the calculation of the relative position of the TT target object (e.g., other ship) at S101 is skipped since it is already obtained.

Next, the controller 24 determines whether the position of the display target is within the first target section 56 illustrated in FIG. 3 (S102). Although the position of the display target is determined by using the relative position of the display target calculated at S101 in this embodiment, it may be determined by using the absolute position. If the position of the display target is within the first target section 56, the controller 24 determines whether the display target satisfies the first display condition described above (S103). Note that, in depicting the display target in the perspective plot section 51, the depict position is calculated based on the relative position (the distance and azimuth of the display target from the first ship) obtained at S101. If the first display condition is satisfied, the display target is depicted in the perspective plot section 51 (S104). If the first display condition is not satisfied, the depiction in the perspective plot section 51 is not performed.

Next, the controller 24 determines whether the position of the display target is within the second target section 57 illustrated in FIG. 3 (S105). If the position of the display target is within the second target section 57, the controller 24 determines whether the display target satisfies the second display condition described above (S106). If the second display condition is satisfied, the display target is depicted in the horizontal plot section 52 (S107). Note that, in depicting the display target in the horizontal plot section 52, the depict position is calculated based on the relative position (the distance and azimuth of the display target from the first ship) obtained at S101. If the second display condition is not satisfied, the depiction in the horizontal plot section 52 is not performed.

The controller 24 repeats the processing from S101 to S107 until the processing is completed for all of the display targets (S108). Thus, the depiction processing of the display target to the three-dimensional navigation image is achieved.

As described above, the multi-function display device 11 of this embodiment includes the display target information memory 31, the display unit 22, and the controller 24. The display target information memory 31 stores the information along with the position at which the information is existed. The display unit 22 displays the information. The controller 24 controls the display unit 22. The controller 24 controls the display unit 22 to simultaneously display the perspective plot section 51 and the horizontal plot section 52. In the perspective plot section 51, the information is displayed when the position at which the information is located is within the first target section 56 and the first display condition is satisfied. The first target section 56 is designed to include the information of the area near the first ship, and the first display condition is designed to determine whether to display the information depending on the target indicated by the information displayed. In the horizontal plot section 52, the information is displayed when the position at which the information is located is within the second target section 57 and the second display condition is satisfied. The second target section 57 is designed to include information of the area farther from the ship compared to the first target section 56, and the second display condition is designed to determine whether to display the information depending on the target indicated by the information. Further, each of the first and second display conditions is designed by the user.

Thus, the multi-function display device 11 finely customizable of each of the display manners for the situation near the ship and the situation of a wide area can be achieved.

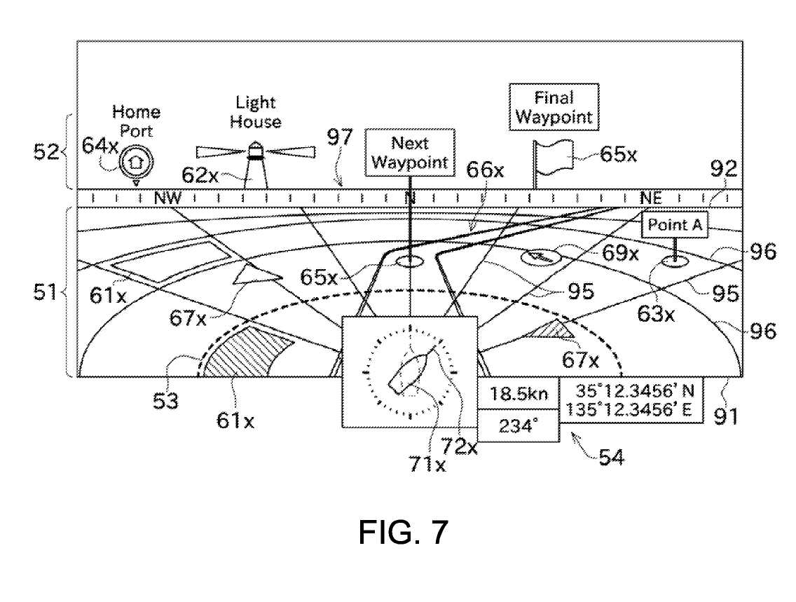

Next, another example of displaying the three-dimensional navigation image is described with reference to FIG. 7.

In other words, in the perspective plot section 51 of the three-dimensional navigation image, the method of expressing the water surface (sea surface) around the first ship in perspective is not limited to drawing a plane with orthogonal coordinates in the one-point perspective as FIG. 4. For example, as illustrated in FIG. 7, a method using radially straight lines 95 radially spreading from the first ship position, and elliptic arcs 96 centering on the first ship position and crashed in the up-and-down directions may be considered. Thus, the water surface is expressed substantially in a polar coordinate plane centering on the first ship position. In the display example of FIG. 7, the guard line 53 forms an elliptic arc.

Note that, in the display example of FIG. 7, an azimuth scale 97 is displayed in a manner of separating the perspective plot section 51 from the horizontal plot section 52. Thus, the user can easily confirm the azimuths of the lighthouse and the homeport and the like displayed as the distant view, by referring to the landmark symbol 62x, the homeport mark 64x or the like, and the azimuth scale 97.

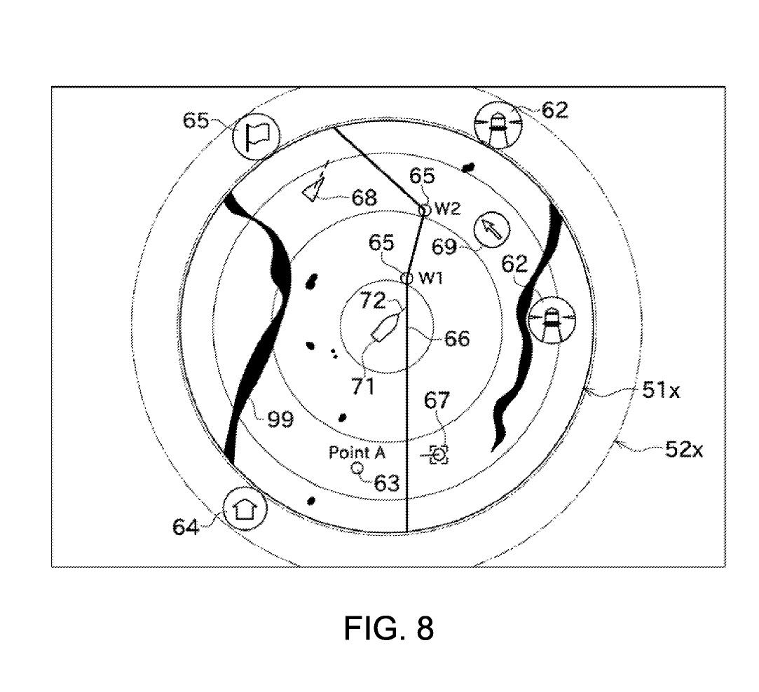

Note that, this disclosure is not limited to creating the three-dimensional navigation image, but may also be applied to create a radar image, etc., which will be described as follows with reference to FIG. 8.

When the user suitably controls the user interface 23 to instruct a radar image to be displayed, the multi-function display device 11 displays on the display unit 22 a view illustrated in FIG. 8. In this view, a radar image including radar echoes 99 in a radar image display section (first display section) 51x having a circular shape is displayed. A boat icon 71 indicating the first ship is displayed at the center of the radar image display section 51x. Moreover, an outer circumferential section (second display section) 52x having an annular shape to surround the radar image display section 51x is displayed simultaneously with the radar image display section 51x. The radar image display section 51x is provided radially inward of the outer circumferential section 52x. Note that, the chain lines illustrated in FIG. 8 are drawn for easier understanding of the range of the outer circumferential section 52x, and they may not actually be displayed on the display unit 22.

In the radar image, when the TT target object, the user registering point, the navigation route, the landmark or the like is within a section where the distance from the ship is less than a predetermined distance (within the first target section) and the first display condition is satisfied, the display unit 22 displays it as in the form of the TT target icon 67, the point mark 63, the intermediate destination marks 65, the route line 66, the landmark symbol 62 or the like at a position corresponding to the distance and azimuth of the display target with respect to the ship, within the radar image display section 51x described above. On the other hand, when the landmark, the final destination, or the homeport is within a section where the distance from the ship is over the predetermined distance (within the second target section) and the second display condition is satisfied, the display unit 22 displays it as in the form of the landmark symbol 62, the destination mark 65, or the homeport mark 64 at a position corresponding to the azimuth of the display target with respect to the ship, within the outer circumferential section 52x described above. Note that, in a case of displaying the display target (e.g., the landmark symbol 62) within the outer circumferential section 52x, the display target is displayed at a position with a fixed distance from the boat icon 71 at the center of the radar image display section 51x regardless of the distance of the display target from the ship.

The setting of the first and second display conditions in the radar image can also be performed on a setting screen similar to the three-dimensional navigation setting screen 100 in FIG. 5. In other words, the user can specify the display target to be displayed within the radar image display section 51x among the display targets within the section where the distance from the ship is less than the predetermined distance, and also specify the display target to be displayed within the outer circumferential section 52x among the display targets within the section where the distance from the ship is over the predetermined distance. Thus, also in the radar image, the fine customization of the displayed manners of the situation near the ship and the situation of a wide area can be achieved, which improves the usefulness of the multi-function display device 11.

Although the preferred embodiment of this disclosure is described, the above configuration may be modified as follows.

The design of the first and second target sections 56 and 57 are not limited to FIG. 3, and may be designed into any shape according to the size of the three-dimensional navigation image, etc. Specifically, the first target section 56 may be designed into a fan shape, for example. Moreover, a modification may be adopted in which without providing the upper limit in the distance from the ship for the second target section 57, the display target is remained displayed within the horizontal plot section 52 as long as the azimuth condition is satisfied regardless of the distance from the ship.

The display mode of the display targets displayed in the three-dimensional navigation image is not limited to the above examples, and may suitably be changed. For example, a modification may be adopted in which the trace of the TT target object (e.g., other ship) is only displayed within the perspective plot section 51 corresponding to the near view. Moreover, a modification may be adopted in which alternative to or in addition to the wind direction-and-speed icon, weather, a water temperature, and an ocean current may be displayed by using icons. Further, among the landmarks, if the channel buoy is at a far distance from the first ship, since it is difficult to be a reference mark, it may be designed not to be displayed in the horizontal plot section 52 corresponding to the distant view.

In the meter section 54, in addition to or alternative to the first ship position and the like, an engine speed, a fuel amount, a fish finding image, wind direction and speed measured by the first ship, a water depth and the like may be displayed. Various modes can be considered for the display mode of the meters, such as a digital display mode, a display mode imitating an analog meter, or a chart display mode. Moreover, the meter section 54 may be disposed on the upper side of the horizontal plot section 52.

The multi-function display device 11 of this embodiment may also be used by being mounted to movable bodies other than ships. Moreover, the function of the multi-function display device 11 may be achieved in a suitable mobile device (e.g., smartphone).

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. An information display device, comprising:
a GNSS receiver configured to receive an own position from a GNSS sensor;
a memory configured to store information along with a position;
a display unit configured to display the information; and
a controller configured to control the display unit,
wherein the controller controls the display unit to simultaneously display a first display section and a second display section,
wherein the information is displayed within the first display section when the position at which the information is located is within a first target section and a first display condition is satisfied, the first target section designed to include information of a near area from the own position, the first display condition designed to determine whether to display the information based on a first predetermined condition,
wherein the information is displayed within the second display section when the position at which the information is located is within a second target section and a second display condition is satisfied, the second target section designed to include information of a farther area from the own position compared to the first target section, the second display condition designed to determine whether to display the information based on a second predetermined condition, and
wherein each of the first and second display conditions is specifiable by a user.

2. The information display device of claim 1, wherein the number of targets indicated by the information for which whether to display is specifiable by the user in specifying the second display condition is smaller than that in specifying the first display condition.

3. The information display device of claim 1, wherein the second display condition includes the first display condition so that a same kind of information in the second display section is also displayed in the first display section.

4. The information display device of claim 1, wherein among the information displayed within the first display section, whether to emphasize the information indicating a target that is detected to be dangerous is specifiable by the user.

5. The information display device of claim 1, wherein within the first display section, the information is displayed small when a distance from the own position is long, and the information is displayed large when the distance is short.

6. The information display device of claim 1, wherein the information displayed within the first display section is dynamic information, and the information displayed within the second display section is static information.

7. The information display device of claim 1, wherein the information displayed within the first display section is either one of information received through external communication and information detected by a sensor, and
wherein the information displayed within the second display section is information obtained from map information.

8. The information display device of claim 7, wherein the information received through the external communication includes any of weather, wind direction, wind speed, water temperature, water current, and information of other ship.

9. The information display device of claim 7, wherein the information detected by the sensor is information detected by either one of a radar and a sonar.

10. The information display device of claim 1, wherein the second display section is disposed on an upper side of the first display section in vertical directions of the first display section.

11. The information display device of claim 1, wherein the first display section has a circular shape, the second display section has an annular shape, and the first display section is disposed radially inward of the second display section.

12. A method of displaying information that is stored along with a position, on a display unit, the method comprising:
causing the display unit to simultaneously display a first display section and a second display section,
wherein the information is displayed within the first display section when the position at which the information is located is within a first target section and a first display condition is satisfied, the first target section designed to include information of a near area from the own position, the first display condition designed to determine whether to display the information based on a first predetermined condition,
wherein the information is displayed within the second display section when the position at which the information is located is within a second target section and a second display condition is satisfied, the second target section designed to include information of a farther area from the own position compared to the first target section, the second display condition designed to determine whether to display the information based on a second predetermined condition, and
wherein each of the first and second display conditions is specifiable by a user.

13. The method of displaying the information of claim 12, wherein the number of targets indicated by the information for which whether to display is specifiable by the user in specifying the second display condition is smaller than that in specifying the first display condition.

14. The method of displaying the information of claim 12, wherein the information displayed within the first display section is dynamic information, and the information displayed within the second display section is static information.

15. The method of displaying the information of claim 12, wherein the information displayed within the first display section is either one of information received through external communication and information detected by a sensor, and
wherein the information displayed within the second display section is information obtained from map information.
